(19) United States
(12) Patent Application Publication
(10) Pub. No.: US 2026/0348206 A1
(43) Pub. Date: Nov. 5, 2026

(54) CHILD SAFETY BIFOLD DOOR LOCK SYSTEM

(71) Applicant: John Cryer, Minneola, FL (US)

(72) Inventor: John Cryer, Minneola, FL (US)

(21) Appl. No.: 19/652,096

(22) Filed: Apr. 20, 2026

Related U.S. Application Data
(60) Provisional application No. 63/798,326, filed on May 1, 2025.

(51) Int. Cl. E05C 1/04; E05C 1/00

(52) U.S. Cl. CPC E05C 1/04; E05C 1/006

(57) ABSTRACT

A child safety bifold door lock system includes a door latch device that is connected to a first bifold door panel, and a door catch device that is connected to the other bifold door panel. The door latch device includes a sliding panel, a knob and a hook that extends out from an inside facing sidewall of the door latch device body. The door catch device includes a generally rectangular-shaped member having an opening along an inside facing sidewall. The door catch device and the door latch device are horizontally aligned such that closing the door will cause the hook to automatically engage the door catch and will position the hook within the opening, thus securing the door in the locked position. The system is unlocked by lifting the knob to raise the hook within the opening.

### CROSS-REFERENCE TO RELATED APPLICATIONS

This application claims the benefit of U.S. Application Ser. No. 63/798,326 filed on May 1, 2025, the contents of which are incorporated herein by reference.

### TECHNICAL FIELD

The following disclosure contemplates various embodiments of a child safety locking system for bifold doors that automatically engages when a door is closed to securely lock the door to prevent the same from being opened by a child.

### BACKGROUND

The statements in this section merely provide background information related to the present disclosure and may not constitute prior art.

Young children are curious by nature and often spend considerable time exploring their surroundings. This exploration often leads them to places like storage closets and/or the kitchen pantry, for example, which have bifold doors. These bifold doors can be especially alluring because they are easy to pull open and sometimes reveal desired items such as snacks or toys, for example.

Unfortunately, this curiosity can quickly turn into a safety concern if the child access food to which they have allergies, cleaning supplies, or heavy items stored on shelves. For this reason, there are many known types of child safety mechanisms which can be secured onto doors. The goal of these products is to prevent the child from opening the door while allowing access by a parent or caregiver.

Although useful, many of these devices are constructed as passive mechanisms that only work when manually locked by the adult. As such, the adult must remember to engage the child safety device each time they open the bifold door. Unfortunately, it is not uncommon for an adult to periodically forget to engage the safety lock, thus allowing the child to open a bifold door which can result in horrible consequences.

The present invention, directed to a child safety bifold door lock system differs from the conventional art in a number of aspects. The manner by which will become more apparent in the description which follows, particularly when read in conjunction with the accompanying drawings.

### SUMMARY OF THE INVENTION

The present invention is directed to a child safety bifold door lock system. One embodiment of the present invention can include a door latch device that is connected to a first bifold door panel, and a door catch device that is connected to the other bifold door panel.

The door latch device can include a main body having a back wall that is secured onto one of the bifold door panels. A latch assembly having a sliding panel can be positioned within the door latch device body and can include a knob that extends out through an opening in the front wall of the door latch device body, and a hook that extends out from an inside facing sidewall of the door latch device body.

The door catch device can include a generally rectangular-shaped member having a back wall that is secured onto the other bifold door panel, and an inside facing sidewall that includes a central opening. The door catch device and the door latch device can be horizontally aligned such that closing the door will cause the hook to automatically engage the door catch and to position the hook within the opening, thus securing the door in the locked position. The system can be unlocked by lifting the knob to raise the hook within the opening, and upon opening the door, the hook will return to the lowered position.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of a child safety bifold door lock system that is useful for understanding the inventive concepts disclosed herein.

FIG. 2 is a perspective view of the door latch device of the system in the first and locked position, in accordance with one embodiment of the invention.

FIG. 3 is a perspective view of the door latch device of the system in the second and unlocked position, in accordance with one embodiment of the invention.

FIG. 4 is a perspective view of the door catch device of the system, in accordance with one embodiment of the invention.

FIG. 5 is a perspective view of the system in operation, in accordance with one embodiment of the invention.

FIG. 6 is a perspective view of the system in operation, wherein the front wall of the door catch device is removed for ease of illustration.

FIG. 7 is another perspective view of the system in operation, wherein the front wall of the door catch device is removed for ease of illustration.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

Any element in a claim that does not explicitly state “means” for performing a specified function or “step” for performing a specified function should not be interpreted as a “means” or “step” clause as specified in 35 U.S.C. 112.

### Definitions

As described herein, a “unit” means a series of identified physical components which are linked together and/or function together to perform a specified function.

As described throughout this document, the terms “about”, “approximately”, “substantially”, and “generally” shall be used interchangeably to describe a feature, shape, or measurement of a component within a tolerance such as, for example, manufacturing tolerances, measurement tolerances, or the like.

As described throughout this document, the term “removably secured” and derivatives thereof shall be used to describe a situation wherein two or more objects are joined together in a non-permanent manner so as to allow the same objects to be repeatedly joined and separated. This can be accomplished through the use of any number of different “connectors”.

Several nonlimiting examples of connectors include, but are not limited to, thread-to-connect, twist-to-connect, and push-to-connect type devices, opposing strips of hook and loop material (e.g., Velcro®), removable adhesive strips, attractively oriented magnetic elements or magnetic and metallic elements, buckles, clamps, clips, and compression fittings, for example.

The term “permanently secured” shall be used to describe a situation wherein two or more objects are joined together in a manner so as to prevent the same objects from being separated. Several nonlimiting examples of permanent connectors include welds, various adhesives such as glue or resin, and hardware such as nuts and bolts, for example.

As described throughout this document, the term “complementary shape,” and “complementary dimension,” shall be used to describe a shape and size of a component that is identical to, or substantially identical to the shape and size of another identified component within a tolerance such as, for example, manufacturing tolerances, measurement tolerances or the like.

As described herein, the term “resilient shape” and derivatives thereof are defined as the ability of a component to maintain a particular shape and to attempt to return to the particular shape after being bent, folded, twisted or otherwise manipulated.

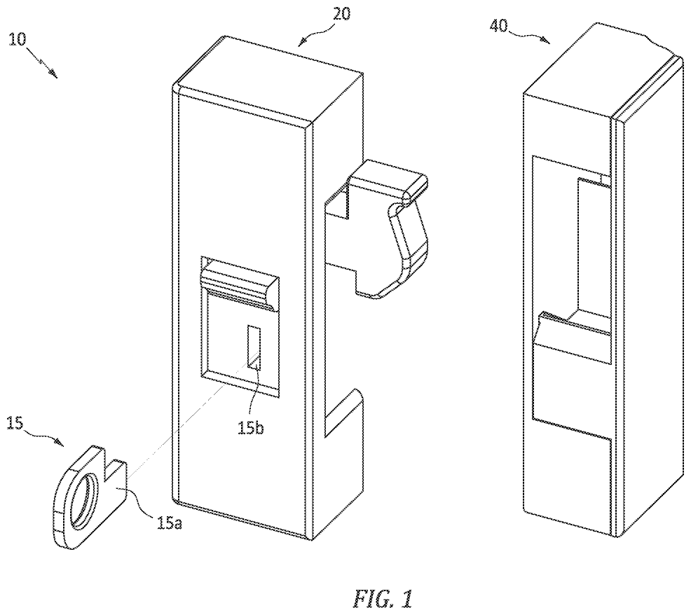

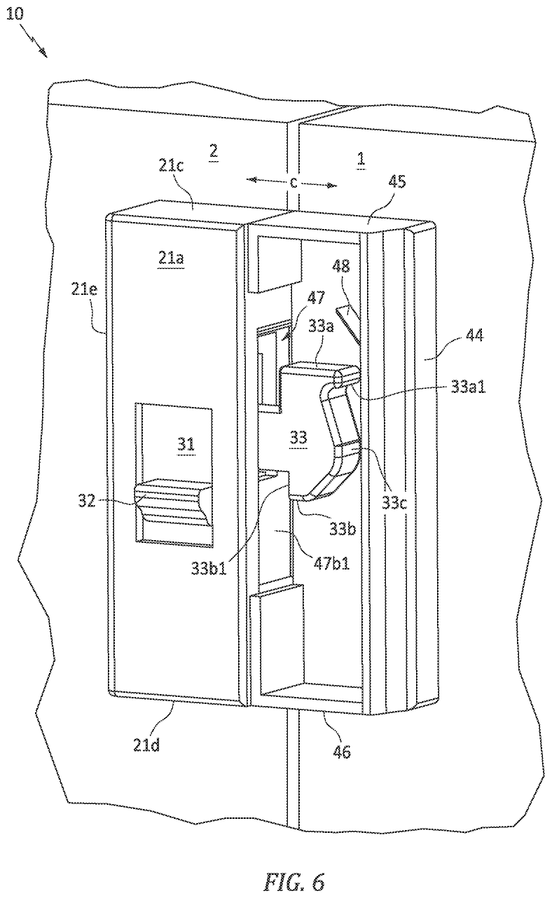

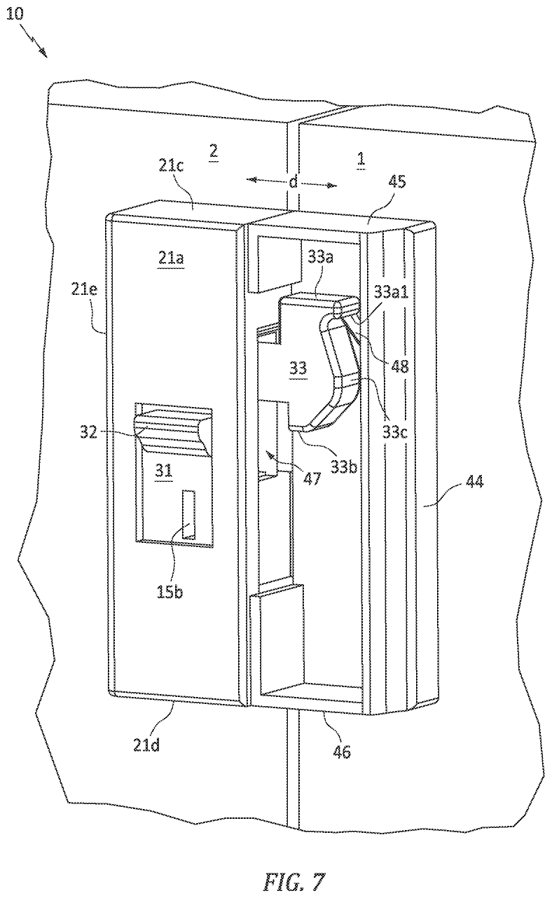

FIGS. 1-7 illustrate one embodiment of a child safety bifold door lock system 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “up,” “down,” “top,” “bottom,” “right,” “left,” “front,” “vertical,” “horizontal,” and derivatives thereof shall relate to the invention as oriented in FIG. 140.

FIG. 1 illustrates one embodiment of a child safety bifold door lock system 10 that includes a retaining key 15, a door latch device 20 and a door catch device 40. As will be described below, the latch and catch devices are designed to be secured onto two panels of a bifold door to selectively prevent the door from being opened.

As shown, the retaining key 15 can include a protruding end 15a that is designed to be positioned within a slotted opening 15b on the door latch device. When so positioned, the body of the key prevents the sliding panel within the latch device from moving and thus secures the latch device in the unlocked position. Such a feature is important as it allows a user to disable the ability of the latch device 20 to automatically engage the catch device 40 and to allow the bifold door to operate normally without having to uninstall the system components from the door. Such a feature being particularly advantageous for use when no children are present and the use of the device is not desired.

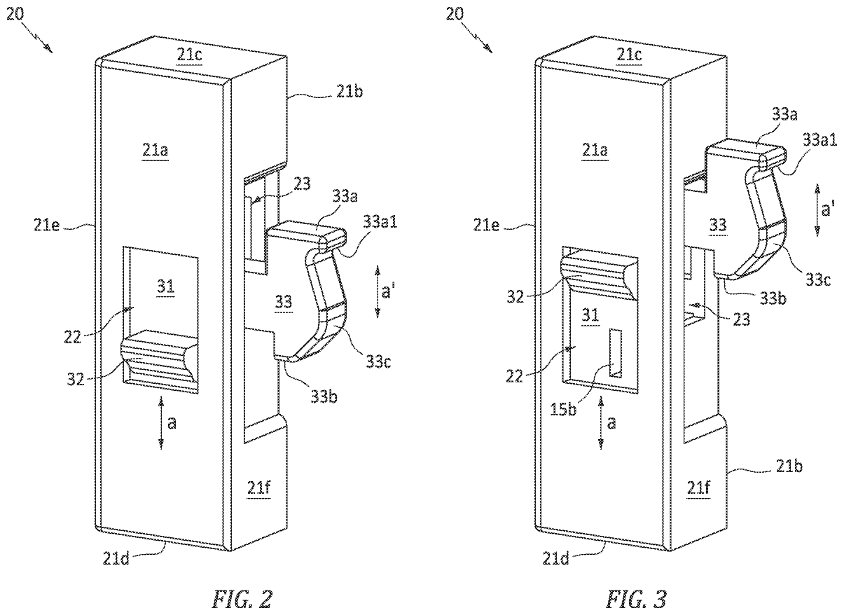

As shown best at FIGS. 2 and 3, one embodiment of the door latch device 20 can include an elongated, generally rectangular-shaped main body having a front wall 21a, a back wall 21b, a top wall 21c, a bottom wall 21d, an outside facing sidewall 21e and an inside facing sidewall 21f that define a hollow interior space.

In one embodiment, a latch assembly having a sliding panel 31, a knob 32 and a hook 33 are slidingly positioned within the main body of the door latch device 20 and function to selectively engage the below described door catch device 40. As described herein, the knob 32 can include any number of different shapes and sizes suitable for being engaged by a human finger and can be positioned so as to extend through a first opening 22 on the front 21a of the main body.

In one embodiment, the hook 33 can include the illustrated double-edged design having a top end 33a, a protruding forward section 33a1, a bottom end 33b, and a curvilinear middle section 33c. The hook 33 can be positioned perpendicular to the knob along the sliding panel so as to extend outward through a second opening 23 on the inside facing sidewall 21f.

As shown, a user can selectively move the knob 32 (arrow a) up and down relative to the main body of the device 20 to impart a complementary movement (arrow a') onto the hook 33. Such a feature allows the device to transition between a first locked position shown at FIG. 2 and a second unlocked position shown at FIG. 3.

Although described above as including a particular shape or size, the door latch device and latch assembly can each include any number of different shapes and sizes. Additionally, the components may be formed from any number of materials that are, for example, relatively strong and stiff for their weight. Several nonlimiting examples include but are not limited to various metals or metal alloys, various plastics/polymers, and/or various composite materials.

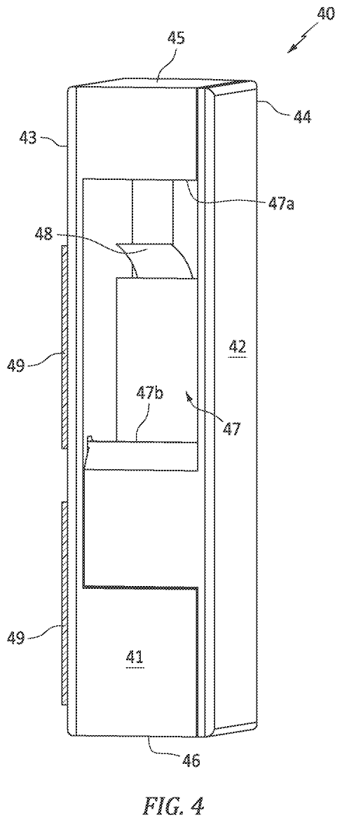

FIG. 4 illustrates one embodiment of a door catch device 40 that includes a generally rectangular-shaped body having an inside facing sidewall 41, a front wall 42, a back wall 43, an outside facing sidewall 44, a top end 45 and a bottom end 46 that define a hollow interior space. In one embodiment, an opening 47 is positioned along the inside facing sidewall 41 and includes an upper lip 47a and a lower lip 47b. Likewise, a resilient angled ledge 48 is positioned within the opening and extends outward from the outside facing sidewall 44. In one embodiment, connectors 49 such as adhesive strips, for example, can be provided to mount the catch device onto a bifold door panel.

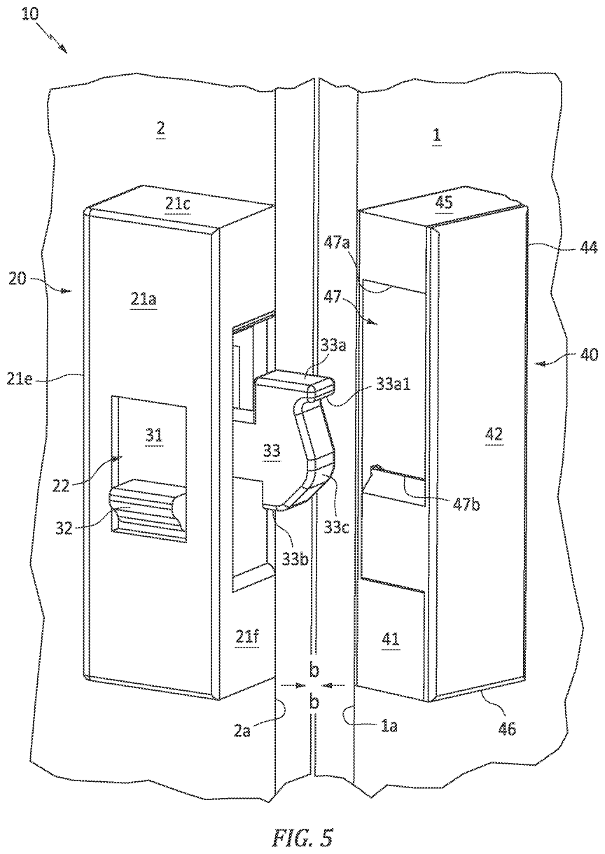

FIGS. 5-7 illustrate one embodiment of the system 10 in operation. As shown, the door catch device 40 can be mounted onto a first panel 1 of the bifold door via the connectors such that the inside facing sidewall 41 is aligned with the edge 1a of the panel. Additionally, the door latch device 20 can be mounted onto a second panel 2 of the bifold door via additional connectors (not shown) such that the inside facing sidewall 21f is aligned with the edge 2a of the panel. When so positioned, the hook 33 will extend outward from the edge 2a and will be aligned with the opening 47 of the door catch device.

The devices 20 and 40 are horizontally aligned and mounted such that as the door swings closed (arrow b), and the two panels 1 and 2 approach each other, the angled middle section 33c of the hook 33 will make contact with the lower lip 47b of the door catch 40. This contact and the continued movement will cause the hook to rise until it passes the threshold of the lip 47b and returns to the resting first locked position at which time the hook will be located entirely within the opening 47.

When so positioned, the inside facing rear wall 33b1 on the bottom end 33b of the hook will be positioned adjacent to the inside facing wall of the lower lip within the opening 47. As such, if a user attempts to open the door (arrow c) the flat rear wall 33b1 of the hook 33 will engage the flat inside wall 47b1 of the lower lip 47b to prevent the components from separating and will thus prevent the door from being opened for so long as the device is in the first locked position.

This functionality is important, as it allows the hook 33 of the door latch device 20 to automatically engage the door catch device 40 when the door is closed and to maintain the door in the locked position without user intervention, thus functioning to automatically lock the door.

When it is desirable to unlock the system and open the door, a user can simply lift the knob 32 to transition to the second unlocked position. In this regard, the hook 33 will move upward and the forward section 33a1 will make contact with the resilient ledge 48. This contact causes the ledge to bend/flex toward the outside facing wall 44 until the protruding section is located above the ledge at which time the ledge will spring back to its resting position. At this time, bottom surface of the protruding forward section 33a1 will rest along the top of the ledge 48 and the device will remain in the second unlocked position until the door is opened (arrow d) and the components are separated.

Such a feature is advantageous as it allows the user to remove their hand from the knob to grab the door handle, thus enabling one handed use of the system when opening the door. Stated differently, without the resilient ledge and protruding section of the hook, a user would have to keep one hand on the knob to keep the device in the unlocked position while using their other hand to pull open the door via the door handle.

In either instance, once the door has been opened and the hook and ledge have been separated, gravity will cause the door latch device 20 to automatically return to the first locked position so as to be ready to automatically engage the door catch 40 when the door is next closed.

As to a further description of the manner and use of the present invention, the same should be apparent from the above description. Accordingly, no further discussion relating to the manner of usage and operation will be provided.

As described herein, one or more elements of the above noted device and system can be secured together utilizing any number of known attachment means such as, for example, screws, glue, compression fittings, and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

Any element in a claim that does not explicitly state “means” for performing a specified function or “step” for performing a specified function should not be interpreted as a “means” or “step” clause as specified in 35 U.S.C. 112. The corresponding structures, materials, acts, and equivalents of all means or step plus function elements in the claims below are intended to include any structure, material, or act for performing the function in combination with other claimed elements as specifically claimed.

The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A child safety system, comprising:
a door latch body that includes a front wall, a back wall, and an inside facing sidewall;
a latch assembly that is positioned within the door latch body, said latch assembly including a hook that extends outward from the inside facing sidewall;
a door catch body having a front wall, a back wall, and an inside facing sidewall; and
an opening that is disposed in the inside facing sidewall of the door catch body, said opening having a lower lip,
wherein the back wall of the door catch body is configured to be secured onto a first panel of a bifold door, and
wherein the back wall of the door latch body is configured to be secured onto a second panel of the bifold door,
wherein the hook is configured to be selectively positioned within the opening of the door catch body to secure the bifold door in a locked position when the first door panel and the second door panel are aligned serially.

2. The system of claim 1, wherein the hook is slidingly connected to the door latch body.

3. The system of claim 2, wherein the hook is configured to slidingly engage the lower lip of the catch body to automatically secure the door in the locked position.

4. The system of claim 1, further comprising:
a sliding panel that is positioned within the door latch body.

5. The system of claim 1, further comprising:
a central opening that is positioned along the front wall of the door latch body.

6. The system of claim 5, further comprising:
a knob that is positioned along the sliding panel, said knob extending through the central opening on the door latch body.

7. The system of claim 6, wherein the hook extends outward from the sliding panel and is oriented perpendicular to the knob.

8. The system of claim 7, wherein the knob is configured to impart a vertical movement onto the hook.

9. The system of claim 1, further comprising:
a second opening that is positioned along the inside facing wall of the door latch body, wherein the hook extends through the second opening.
